(19) United States
(12) Patent Application Publication
(10) Pub. No.: US 2025/0021994 A1
(43) Pub. Date: Jan. 16, 2025

(54) DISTRIBUTED COLLABORATIVE PRIVACY CALCULATION METHOD AND SYSTEM FOR CARBON EMISSION IN A PLURALITY OF POWER GRIDS

(71) Applicant: BIG DATA CENTER OF STATE GRID CORPORATION OF CHINA, Beijing (CN)

(72) Inventors: Wei Yang, Beijing (CN); Xiang Chen, Beijing (CN); Jinwei Song, Beijing (CN); Wenli Liu, Beijing (CN); Jimeng Song, Beijing (CN); Xin Shi, Beijing (CN); Qiheng Yuan, Beijing (CN); Yushu Zhang, Beijing (CN); Yihong Zhang, Beijing (CN); Wensi Liu, Beijing (CN); Peng Jiang, Beijing (CN); Yanxi Li, Beijing (CN)

(21) Appl. No.: 18/897,016

(22) Filed: Sep. 26, 2024

Related U.S. Application Data
(63) Continuation of application No. PCT/CN2024/080721, filed on Mar. 8, 2024.

(30) Foreign Application Priority Data
Mar. 17, 2023 (CN) 202310259754.8

(51) Int. Cl. G06Q 30/018

(52) U.S. Cl. CPC G06Q 30/018

(57) ABSTRACT

Provided are a distributed collaborative privacy calculation method and system for carbon emission in a plurality of power grids. An electricity quantity exchange matrix between regions, and a power generation information matrix, an electricity quantity exchange matrix, and a power-generation carbon emission information matrix of each region are constructed. A corresponding electricity carbon flow information matrix is calculated based on the power generation information matrix and the electricity quantity exchange matrix of each region. An electricity carbon emission balance equation is constructed, and an electricity carbon emission factor matrix of each region is calculated, where the electricity carbon emission factor matrix is constituted by an electricity carbon emission factor of a sub-region. The present disclosure constructs the electricity carbon emission balance equation by using a matrix relationship based on transferred electricity quantity between the regions and corresponding electricity carbon flow information and power-generation carbon emission information of each region.

### CROSS REFERENCE TO RELATED APPLICATIONS

The present application is a Continuation Application of PCT Application No. PCT/CN2024/080721 filed on Mar. 8, 2024, which claims the benefit of Chinese Patent Application No. 202310259754.8 filed on Mar. 17, 2023. All the above are hereby incorporated by reference in their entirety.

### TECHNICAL FIELD

The present disclosure relates to the field of carbon emission accounting in a power grid, and specifically, to a distributed collaborative privacy calculation method and system for carbon emission in a plurality of power grids.

### BACKGROUND

Electricity carbon emission intensity, also known as an electricity carbon emission factor, refers to a carbon dioxide emission amount per unit electricity consumption. In other words, the electricity carbon emission intensity is calculated by dividing a carbon emission amount by a total electricity consumption. This indicator can be used to analyze a relationship between an electricity consumption and a carbon emission amount in a region. A carbon intensity indicator can also quantitatively measure a development level of clean energy using electricity in a country or region, and is of great significance for monitoring, analyzing, and predicting macro green development in a region. A regional electricity carbon emission factor can be used to enable an enterprise in a region to calculate indirect carbon emission caused by electricity usage of the enterprise. In a specific calculation method, the enterprise multiplies the regional electricity carbon emission factor by an electricity quantity used by the enterprise in the region. This method is in line with a “location-based method” proposed by a greenhouse gas (GHG) protocol. After calculating an electricity carbon emission amount of the enterprise, the enterprise can purchase a green certificate as required or adopt other carbon reduction measures to reduce its carbon emissions.

At present, each country generally completes power supply through collaboration of a plurality of regions, and each region is responsible for power supply of a plurality of sub-regions, with at least one power grid disposed in each sub-region. At present, data of each region is kept confidential, and only public data is disclosed. Therefore, when a carbon emission amount in each sub-region of a country is accounted, cross-organization data fusion is required. This can easily lead to leakage of scheduling data between important sub-regions of each organization. In addition, there are slight differences between a range of a power grid disposed in each sub-region of the region and a range of the sub-region. If an average carbon emission factor in a range of each power grid is used for calculation, the carbon emission factor covers an excessive range. A calculation result cannot accurately reflect a differential structure of a power source in each sub-region, resulting in a different electricity carbon emission factor for each sub-region. This further leads to inaccurate accounting of an indirect carbon dioxide emission amount in each sub-region.

### SUMMARY

In order to overcome the above shortcomings in the prior art, the present disclosure provides a distributed collaborative privacy calculation method and system for carbon emission in a plurality of power grids.

The present disclosure provides the following technical solutions.

The present disclosure provides a distributed collaborative privacy calculation method for carbon emission in a plurality of power grids, including:
obtaining a transferred electricity quantity between regions, obtaining a generating capacity of a sub-region under jurisdiction of each of the regions, a transferred electricity quantity between sub-regions, and a generating capacity of energy of the sub-region, and constructing an electricity quantity exchange matrix between the regions, and a power generation information matrix, an electricity quantity exchange matrix, and a power-generation carbon emission information matrix of each of the regions based on the obtained information;
calculating a corresponding electricity carbon flow information matrix based on the power generation information matrix and the electricity quantity exchange matrix of each of the regions; and
constructing an electricity carbon emission balance equation based on the electricity carbon flow information matrix and the power-generation carbon emission information matrix of each of the regions, and the electricity quantity exchange matrix between the regions, and calculating an electricity carbon emission factor matrix of each of the regions, where the electricity carbon emission factor matrix of the region includes an electricity carbon emission factor of the sub-region under the jurisdiction of the region.

Preferably, the electricity carbon emission balance equation is expressed by a following calculation formula:

$$[ \begin{matrix}{M}_{1} & … & {P}_{τ1} & … & {P}_{L 1} \\ ⋮ & ⋱ & ⋮ & … & ⋮ \\ {P}_{1 τ} & … & {M}_{τ} & … & {P}_{L τ} \\ ⋮ & … & ⋮ & ⋱ & ⋮ \\ {P}_{1 L} & … & {P}_{τ L} & … & {M}_{L}\end{matrix} ] [ \begin{matrix}{λ}_{1} \\ ⋮ \\ {λ}_{τ} \\ ⋮ \\ {λ}_{L}\end{matrix} ] = [ \begin{matrix}{C}_{1} \\ ⋮ \\ {C}_{τ} \\ ⋮ \\ {C}_{L}\end{matrix} ]$$

where M_{τ} represents an electricity carbon flow information matrix of a τ^{th} region; P_{τL} represents an electricity quantity exchange matrix from the τ^{th} region to an L^{th} region; P_{Lτ} represents an electricity quantity exchange matrix from the L^{th} region to the τ^{th} region; λ_{τ} represents an electricity carbon emission factor matrix of the τ^{th} region; and C_{τ} represents a power-generation carbon emission information matrix of the τ^{th} region.

Preferably, the electricity carbon emission factor matrix is calculated according to a following calculation formula:

$${λ}_{τ} = {λ}_{τ}^{( 0 )} - {\sum }_{μ} {D}_{μ τ} {λ}_{μ}$$

where

$${λ}_{τ}^{( 0 )} = {M}_{τ}^{- 1} {C}_{τ}$$

$${D}_{μτ} = {M}_{τ}^{- 1} {P}_{μτ}$$

where λ_{τ} represents the electricity carbon emission factor matrix of the τ^{th} region; C_{τ} represents the power-generation carbon emission information matrix of the τ^{th} region; λ_{μ} represents an electricity carbon emission factor matrix of a μ^{th} region; P_{μτ} represents an electricity quantity exchange matrix from the μ^{th} region to the τ^{th} region; M_{τ} represents the electricity carbon flow information matrix of the τ^{th} region; D_{μτ} represents an interactive power flow matrix between sub-regions from the μ^{th} region to the τ^{th} region; and λ_{τ}⁽⁰⁾ represents an initial iteration value of the electricity carbon emission factor matrix of the τ^{th} region.

Preferably, the power generation information matrix of the region is expressed by a following calculation formula:

$$E = [ \begin{matrix}{E}_{1} & 0 & … & 0 & … & 0 \\ 0 & {E}_{2} & … & 0 & … & 0 \\ ⋮ & ⋮ & ⋱ & ⋮ & … & ⋮ \\ 0 & 0 & … & {E}_{i} & … & 0 \\ ⋮ & ⋮ & ⋮ & ⋮ & ⋱ & ⋮ \\ 0 & 0 & … & 0 & … & {E}_{N}\end{matrix} ]$$

where E represents the power generation information matrix of the region, Eᵢ represents a generating capacity of an i^{th} sub-region under the jurisdiction of the region, and N represents a quantity of sub-regions under the jurisdiction of the region;

the electricity quantity exchange matrix of the region is expressed by a following calculation formula:

$$P = [ \begin{matrix}0 & {P}_{2 , 1} & … & {P}_{i , 1} & … & {P}_{N , 1} \\ {P}_{1 , 2} & 0 & … & {P}_{i , 2} & … & {P}_{N , 2} \\ ⋮ & ⋮ & ⋱ & ⋮ & … & ⋮ \\ {P}_{1 , j} & {P}_{2 , j} & … & 0 & … & {P}_{N , j} \\ ⋮ & ⋮ & ⋮ & ⋮ & ⋱ & ⋮ \\ {P}_{1 , N} & {P}_{2 , N} & … & {P}_{i , N} & ⋯ & 0\end{matrix} ]$$

where P represents the electricity quantity exchange matrix of the region, P_{i,j} represents a transferred electricity quantity from the i^{th} sub-region to a j^{th} sub-region, and N represents the quantity of sub-regions under the jurisdiction of the region; and

the power-generation carbon emission information matrix of the region is expressed by a following calculation formula:

$$C = [ \begin{matrix}{\sum }_{m} {E}_{1 , m} {ε}_{m} \\ {\sum }_{m} {E}_{2 , m} {ε}_{m} \\ ⋮ \\ {\sum }_{m} {E}_{i , m} {ε}_{m} \\ ⋮ \\ {\sum }_{m} {E}_{N , m} {ε}_{m}\end{matrix} ]$$

where C represents the power-generation carbon emission information matrix of the region, E_{i,m} represents a generating capacity of an m^{th} type of energy in the i^{th} sub-region, and εₘ represents a power-generation carbon emission factor corresponding to the generating capacity of the m^{th} type of energy.

Preferably, the electricity carbon flow information matrix of the region is calculated according to a following calculation formula:

$$M = E - P + diag ( P [ 1 ] )$$

where M represents the electricity carbon flow information matrix of the region, E represents the power generation information matrix of the region, P represents the electricity quantity exchange matrix of the region, [1] represents a vector that contains only 1, P[1] represents a vector obtained by multiplying the P and the [1], and diag(P[1]) represents an operation of placing the vector on a diagonal of a matrix, with a non-diagonal element being 0.

Preferably, after the calculating an electricity carbon emission factor matrix of each of the regions, the method further includes:
iteratively correcting the electricity carbon emission factor matrix between the regions pairwise by using a block-Jacobi iteration method based on a preset iteration termination threshold, until the iteration satisfies the iteration termination threshold, and obtaining an electricity carbon emission factor matrix of each of the regions after the iterative correction.

Based on a same inventive concept, the present disclosure further provides a distributed collaborative privacy calculation system for carbon emission in a plurality of power grids, including:
a matrix construction module configured to obtain a transferred electricity quantity between regions, obtain a generating capacity of a sub-region under jurisdiction of each of the regions, a transferred electricity quantity between sub-regions, and a generating capacity of energy of the sub-region, and construct an electricity quantity exchange matrix between the regions, and a power generation information matrix, an electricity quantity exchange matrix, and a power-generation carbon emission information matrix of each of the regions based on the obtained information;
a matrix calculation module configured to calculate a corresponding electricity carbon flow information matrix based on the power generation information matrix and the electricity quantity exchange matrix of each of the region; and
an electricity carbon emission factor calculation module configured to construct an electricity carbon emission balance equation based on the electricity carbon flow information matrix and the power-generation carbon emission information matrix of each of the regions, and the electricity quantity exchange matrix between the regions, and calculate an electricity carbon emission factor matrix of each of the regions, where the electricity carbon emission factor matrix of the region includes an electricity carbon emission factor of the sub-region under the jurisdiction of the region.

Preferably, the electricity carbon emission balance equation in the electricity carbon emission factor calculation module is expressed by a following calculation formula:

$$[ \begin{matrix}{M}_{1} & … & {P}_{τ1} & … & {P}_{L 1} \\ ⋮ & ⋱ & ⋮ & … & ⋮ \\ {P}_{1 τ} & … & {M}_{τ} & … & {P}_{L τ} \\ ⋮ & … & ⋮ & ⋱ & ⋮ \\ {P}_{1 L} & … & {P}_{τ L} & … & {M}_{L}\end{matrix} ] [ \begin{matrix}{λ}_{1} \\ ⋮ \\ {λ}_{τ} \\ ⋮ \\ {λ}_{L}\end{matrix} ] = [ \begin{matrix}{C}_{1} \\ ⋮ \\ {C}_{τ} \\ ⋮ \\ {C}_{L}\end{matrix} ]$$

where Mτ represents an electricity carbon flow information matrix of a τ^{th} region; P_{τL} represents an electricity quantity exchange matrix from the τ^{th} region to an L^{th} region; P_{Lτ} represents an electricity quantity exchange matrix from the L^{th} region to the τ^{th} region; λ_{τ} represents an electricity carbon emission factor matrix of the τ^{th} region; and C_{τ} represents a power-generation carbon emission information matrix of the τ^{th} region.

Preferably, the electricity carbon emission factor matrix in the electricity carbon emission factor calculation module is calculated according to a following calculation formula:

$${λ}_{τ} = {λ}_{τ}^{( 0 )} - {\sum }_{μ} {D}_{μ τ} {λ}_{μ}$$

where

$${λ}_{τ}^{( 0 )} = {M}_{τ}^{- 1} {C}_{τ}$$

$${D}_{μτ} = {M}_{τ}^{- 1} {P}_{μτ}$$

where λ_{τ} represents the electricity carbon emission factor matrix of the τ^{th} region; C_{τ} represents the power-generation carbon emission information matrix of the τ^{th} region; λ_{μ} represents an electricity carbon emission factor matrix of a μ^{th} region; P_{μτ} represents an electricity quantity exchange matrix from the μ^{th} region to the τ^{th} region; M_{τ} represents the electricity carbon flow information matrix of the τ^{th} region; D_{μτ} represents an interactive power flow matrix between sub-regions from the μ^{th} region to the τ^{th} region; and λ_{τ}⁽⁰⁾ represents an initial iteration value of the electricity carbon emission factor matrix of the τ^{th} region.

Preferably, the power generation information matrix of the region in the matrix construction module is expressed by a following calculation formula:

$$E = [ \begin{matrix}{E}_{1} & 0 & … & 0 & … & 0 \\ 0 & {E}_{2} & … & 0 & … & 0 \\ ⋮ & ⋮ & ⋱ & ⋮ & … & ⋮ \\ 0 & 0 & … & {E}_{i} & … & 0 \\ ⋮ & ⋮ & ⋮ & ⋮ & ⋱ & ⋮ \\ 0 & 0 & … & 0 & … & {E}_{N}\end{matrix} ]$$

where E represents the power generation information matrix of the region, Eᵢ represents a generating capacity of an i^{th} sub-region under the jurisdiction of the region, and N represents a quantity of sub-regions under the jurisdiction of the region;
the electricity quantity exchange matrix of the region in the matrix construction module is expressed by a following calculation formula:

$$P = [ \begin{matrix}0 & {P}_{2 , 1} & … & {P}_{i , 1} & … & {P}_{N , 1} \\ {P}_{1 , 2} & 0 & … & {P}_{i , 2} & … & {P}_{N , 2} \\ ⋮ & ⋮ & ⋱ & ⋮ & … & ⋮ \\ {P}_{1 , j} & {P}_{2 , j} & … & 0 & … & {P}_{N , j} \\ ⋮ & ⋮ & ⋮ & ⋮ & ⋱ & ⋮ \\ {P}_{1 , N} & {P}_{2 , N} & … & {P}_{i , N} & … & 0\end{matrix} ]$$

where P represents the electricity quantity exchange matrix of the region, P_{i,j} represents a transferred electricity quantity from the i^{th} sub-region to a j^{th} sub-region, and N represents the quantity of sub-regions under the jurisdiction of the region; and
the power-generation carbon emission information matrix of the region in the matrix construction module is expressed by a following calculation formula:

$$C = [ \begin{matrix}{\sum }_{m} {E}_{1 , m} {ε}_{m} \\ {\sum }_{m} {E}_{2 , m} {ε}_{m} \\ ⋮ \\ {\sum }_{m} {E}_{i , m} {ε}_{m} \\ ⋮ \\ {\sum }_{m} {E}_{N , m} {ε}_{m}\end{matrix} ]$$

where C represents the power-generation carbon emission information matrix of the region, E_{i,m} represents a generating capacity of an m^{th} type of energy in the i^{th} sub-region, and εₘ represents a power-generation carbon emission factor corresponding to the generating capacity of the m^{th} type of energy.

Preferably, the electricity carbon flow information matrix of the region in the matrix calculation module is calculated according to a following calculation formula:

$$M = E - P + diag ( P [ 1 ] )$$

where M represents the electricity carbon flow information matrix of the region, E represents the power generation information matrix of the region, P represents the electricity quantity exchange matrix of the region, [1] represents a vector that contains only 1, P[1] represents a vector obtained by multiplying the P and the [1], and diag(P[1]) represents an operation of placing the vector on a diagonal of a matrix, with a non-diagonal element being 0.

Preferably, after the electricity carbon emission factor calculation module calculates the electricity carbon emission factor matrix of each of the regions, the system further includes:
an iterative correction module configured to iteratively correct the electricity carbon emission factor matrix between the regions pairwise by using a block-Jacobi iteration method based on a preset iteration termination threshold, until the iteration satisfies the iteration termination threshold, and obtain an electricity carbon emission factor matrix of each of the regions after the iterative correction.

Based on a same inventive concept, the present disclosure further provides a computer device, including at least one processor, and a memory configured to store at least one program, where
the at least one program is executed by the at least one processor to implement the above distributed collaborative privacy calculation method for carbon emission in a plurality of power grids.

Based on a same inventive concept, the present disclosure further provides a computer-readable storage medium, where a computer program is stored on the computer-readable storage medium, and the computer program is executed to implement the above distributed collaborative privacy calculation method for carbon emission in a plurality of power grids.

Compared with the closest prior art, the present disclosure has the following beneficial effects:

The present disclosure provides a distributed collaborative privacy calculation method and system for carbon emission in a plurality of power grids. A transferred electricity quantity between regions is obtained, a generating capacity of a sub-region under jurisdiction of each region, a transferred electricity quantity between sub-regions, and a generating capacity of energy of the sub-region are obtained, and an electricity quantity exchange matrix between the regions, and a power generation information matrix, an electricity quantity exchange matrix, and a power-generation carbon emission information matrix of each region are constructed based on the obtained information. A corresponding electricity carbon flow information matrix is calculated based on the power generation information matrix and the electricity quantity exchange matrix of each region. An electricity carbon emission balance equation is constructed based on the electricity carbon flow information matrix and the power-generation carbon emission information matrix of each region, and the electricity quantity exchange matrix between the regions. An electricity carbon emission factor matrix of each region is calculated, where the electricity carbon emission factor matrix is constituted by an electricity carbon emission factor of the sub-region under the jurisdiction of the region. The present disclosure constructs the electricity carbon emission balance equation by using a matrix relationship based on the transferred electricity quantity between the regions and corresponding electricity carbon flow information and power-generation carbon emission information of each region, thereby calculating an electricity carbon emission factor of each sub-region under the jurisdiction of each region. This ensures confidentiality of data in each region while accurately calculating the electricity carbon emission factor of each sub-region.

### BRIEF DESCRIPTION OF THE DRAWINGS

FIG. 1 is a schematic flowchart of a distributed collaborative privacy calculation method for carbon emission in a plurality of power grids according to the present disclosure;

FIG. 2 is a schematic diagram showing communication connection between terminals in each region according to the present disclosure;

FIG. 3 is a schematic diagram of a calculation procedure of a distributed collaborative privacy calculation method for carbon emission in a plurality of power grids according to the present disclosure;

FIG. 4 is a schematic diagram of a software module by taking two regions A and B as an example according to the present disclosure; and

FIG. 5 is a schematic diagram of connection of a distributed collaborative privacy calculation system for carbon emission in a plurality of power grids according to the present disclosure.

### DETAILED DESCRIPTION

The specific implementations of the present disclosure will be further described in detail with reference to the accompanying drawings.

### Embodiment 1

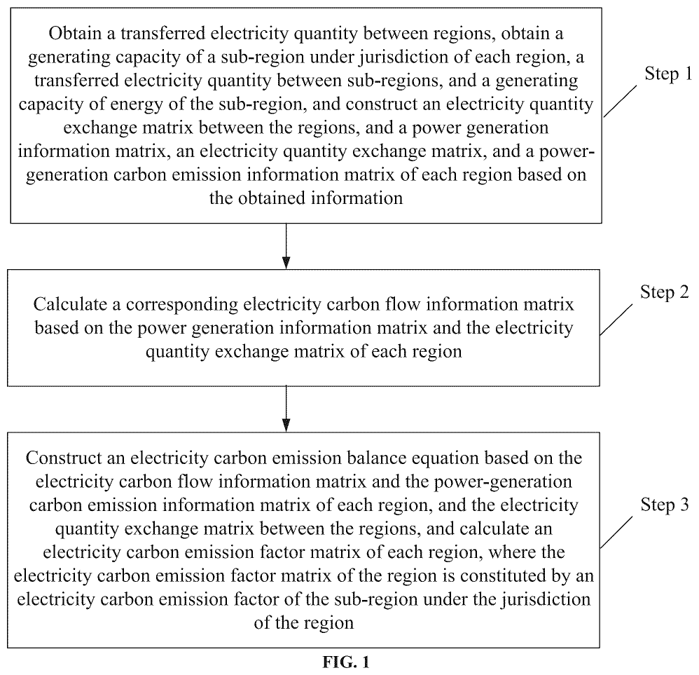

The present disclosure provides a distributed collaborative privacy calculation method for carbon emission in a plurality of power grids. As shown in FIG. 1, the method includes following steps:

Step 1: Obtain a transferred electricity quantity between regions, obtain a generating capacity of a sub-region under jurisdiction of each region, a transferred electricity quantity between sub-regions, and a generating capacity of energy of the sub-region, and construct an electricity quantity exchange matrix between the regions, and a power generation information matrix, an electricity quantity exchange matrix, and a power-generation carbon emission information matrix of each region based on the obtained information.

Step 2: Calculate a corresponding electricity carbon flow information matrix based on the power generation information matrix and the electricity quantity exchange matrix of each region.

Step 3: Construct an electricity carbon emission balance equation based on the electricity carbon flow information matrix and the power-generation carbon emission information matrix of each region, and the electricity quantity exchange matrix between the regions, and calculate an electricity carbon emission factor matrix of each region, where the electricity carbon emission factor matrix of the region is constituted by an electricity carbon emission factor of the sub-region under the jurisdiction of the region.

The method provided in the present disclosure combines scheduling information between a plurality of sub-regions under the jurisdiction of the regions and electricity quantity information received by each sub-region from the other party, performs transformation, and transmits transformed information to the other party to calculate an electricity carbon emission factor of a provincial power grid under the jurisdiction of the entire region. This speed is relatively high, and can ensure protect inter-provincial scheduling information, inter-provincial power generation information, and the like.

In the step 1 of the present disclosure, the power generation information matrix of the region is expressed by a following calculation formula:

$$E = [ \begin{matrix}{E}_{1} & 0 & … & 0 & … & 0 \\ 0 & {E}_{2} & … & 0 & … & 0 \\ ⋮ & ⋮ & ⋱ & ⋮ & … & ⋮ \\ 0 & 0 & … & {E}_{i} & … & 0 \\ ⋮ & ⋮ & ⋮ & ⋮ & ⋱ & ⋮ \\ 0 & 0 & … & 0 & … & {E}_{N}\end{matrix} ]$$

In the above formula, E represents the power generation information matrix of the region, Eᵢ represents a generating capacity of an i^{th} sub-region under the jurisdiction of the region, and N represents a quantity of sub-regions under the jurisdiction of the region.

The electricity quantity exchange matrix of the region is expressed by a following calculation formula:

$$P = [ \begin{matrix}0 & {P}_{2 , 1} & … & {P}_{i , 1} & … & {P}_{N , 1} \\ {P}_{1 , 2} & 0 & … & {P}_{i , 2} & … & {P}_{N , 2} \\ ⋮ & ⋮ & ⋱ & ⋮ & … & ⋮ \\ {P}_{1 , j} & {P}_{2 , j} & … & 0 & … & {P}_{N , j} \\ ⋮ & ⋮ & ⋮ & ⋮ & ⋱ & ⋮ \\ {P}_{1 , N} & {P}_{2 , N} & … & {P}_{i , N} & … & 0\end{matrix} ]$$

In the above formula, P represents the electricity quantity exchange matrix of the region, P_{i,j} represents a transferred electricity quantity from the i^{th} sub-region to a j^{th} sub-region, and N represents the quantity of sub-regions under the jurisdiction of the region.

The power-generation carbon emission information matrix of the region is expressed by a following calculation formula:

$$C = [ \begin{matrix}{\sum }_{m} {E}_{1 , m} {ε}_{m} \\ {\sum }_{m} {E}_{2 , m} {ε}_{m} \\ ⋮ \\ {\sum }_{m} {E}_{i , m} {ε}_{m} \\ ⋮ \\ {\sum }_{m} {E}_{N , m} {ε}_{m}\end{matrix} ]$$

In the above formula, C represents the power-generation carbon emission information matrix of the region, E_{i,m} represents a generating capacity of an m^{th} type of energy in the i^{th} sub-region, and εₘ represents a power-generation carbon emission factor corresponding to the generating capacity of the m^{th} type of energy.

Based on the above description, in the step 2 , the electricity carbon flow information matrix of the region is calculated according to a following calculation formula:

$$M = E - P + diag ( P [ 1 ] )$$

In the above formula, M represents the electricity carbon flow information matrix of the region, E represents the power generation information matrix of the region, P represents the electricity quantity exchange matrix of the region, [1] represents a vector that contains only 1, P[1] represents a vector obtained by multiplying the P and the [1], and diag(P[1]) represents an operation of placing the vector P[1] on a diagonal of a matrix, with a non-diagonal element being 0.

In this case, as a basis of the step 3, an electricity carbon emission balance equation set is constructed:

$$M λ = C$$

A following equation is solved:

$$λ = {M}^{- 1} C$$

In the above equation, λ represents the electricity carbon emission factor matrix of the region.

Therefore, when inter-provincial power scheduling information of a power grid in each sub-region under the jurisdiction of each region is concentrated for operation, important respective data cannot be prevented from being disclosed. The step 3 of the present disclosure divides the above electricity carbon emission balance equation set into matrix blocks.

Therefore, in the step 3, the electricity carbon emission balance equation is expressed by a following calculation formula:

$$[ \begin{matrix}{M}_{1} & … & {P}_{τ1} & … & {P}_{L 1} \\ ⋮ & ⋱ & ⋮ & … & ⋮ \\ {P}_{1 τ} & … & {M}_{τ} & … & {P}_{L τ} \\ ⋮ & … & ⋮ & ⋱ & ⋮ \\ {P}_{1 L} & … & {P}_{τ L} & … & {M}_{L}\end{matrix} ] [ \begin{matrix}{λ}_{1} \\ ⋮ \\ {λ}_{τ} \\ ⋮ \\ {λ}_{L}\end{matrix} ] = [ \begin{matrix}{C}_{1} \\ ⋮ \\ {C}_{τ} \\ ⋮ \\ {C}_{L}\end{matrix} ]$$

In the above formula, L represents a quantity of regions; M_{τ} represents an electricity carbon flow information matrix of a τ^{th} region; P_{τL} represents an electricity quantity exchange matrix from the τ^{th} region to an L^{th} region; P_{Lτ} represents an electricity quantity exchange matrix from the L^{th} region to the τ^{th} region; λ_{τ} represents an electricity carbon emission factor matrix of the τ^{th} region; and C_{τ} represents a power-generation carbon emission information matrix of the τ^{th} region.

The electricity carbon emission factor matrix is calculated according to a following calculation formula:

$${λ}_{τ} = {λ}_{τ}^{( 0 )} - {\sum }_{μ} {D}_{μ τ} {λ}_{μ}$$

In the above formula,

$${λ}_{τ}^{( 0 )} = {M}_{τ}^{- 1} {C}_{τ}$$

$${D}_{μτ} = {M}_{τ}^{- 1} {P}_{μτ}$$

In the above formulas, λ_{τ} represents the electricity carbon emission factor matrix of the τ^{th} region; C_{τ} represents the power-generation carbon emission information matrix of the τ^{th} region; λ_{μ} represents an electricity carbon emission factor matrix of a μ^{th} region; P_{μτ} represents an electricity quantity exchange matrix from the μ^{th} region to the λ^{th} region; MT represents the electricity carbon flow information matrix of the τ^{th} region; D_{μτ} represents an interactive power flow matrix between sub-regions from the μ^{th} region to the τ^{th} region; and λ_{τ}⁽⁰⁾ represents an initial iteration value of the electricity carbon emission factor matrix of the τ^{th} region.

In addition, after the calculating an electricity carbon emission factor matrix of each of the regions, the method further includes:
iteratively correcting the electricity carbon emission factor matrix between the regions pairwise by using a block-Jacobi iteration method based on a preset iteration termination threshold, until the iteration satisfies the iteration termination threshold, and obtaining an electricity carbon emission factor matrix of each region after the iterative correction.

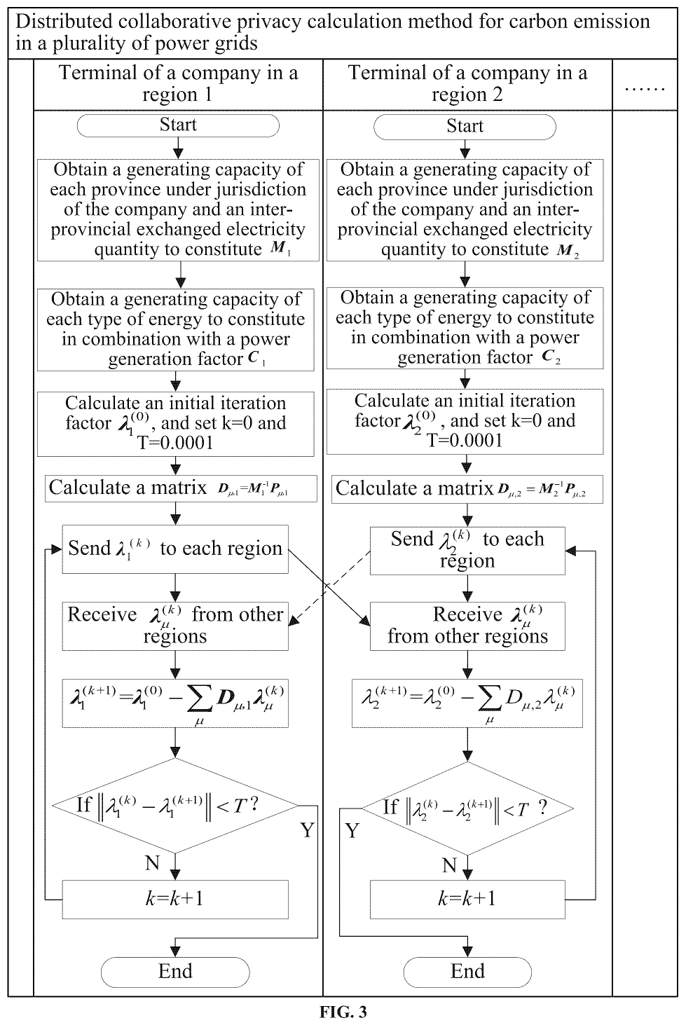

Referring to FIG. 3, the iteration is performed in a following manner:
(1) Set an initial iteration value to 0 (namely, k=0) and an iteration termination threshold to 0.0001 (namely, T=0.0001), where λ_{τ}⁽⁰⁾ represents a first iteration value.
(2) Each region sends λ_{τ}^{(k)} to other regions through interconnected terminals.
(3) Each region receives λ_{μ}^{(k)} from other regions and performs iterative calculation.

$${λ}_{τ}^{( k + 1 )} = {λ}_{τ}^{( 0 )} - {\sum }_{μ} {D}_{μτ} {λ}_{μ}^{( k )}$$

(4) Each region determines whether a following condition is met:

$$‖ {λ}_{τ}^{( k + 1 )} - {λ}_{τ}^{( k )} ‖ < T$$

If the above condition is met, the iteration is terminated. If the above condition is not met, k=k+1 is set and the step (2) is performed until the iteration is terminated.

This embodiment takes regions A, B, and C as an example to construct the electricity carbon emission balance equation:

$$[ \begin{matrix}{M}_{a} & {P}_{ba} & {P}_{ca} \\ {P}_{ab} & {M}_{b} & {P}_{cb} \\ {P}_{ac} & {P}_{bc} & {M}_{c}\end{matrix} ] [ \begin{matrix}{λ}_{a} \\ {λ}_{b} \\ {λ}_{c}\end{matrix} ] = [ \begin{matrix}{C}_{a} \\ {C}_{b} \\ {C}_{c}\end{matrix} ]$$

In the above equation, Mₐ represents an electricity carbon flow information matrix of the region A, M_{b} represents an electricity carbon flow information matrix of the region B, M_{c} represents an electricity carbon flow information matrix of the region C, P_{ba} represents an electricity quantity exchange matrix from the region B to the region A, P_{ca} represents an electricity quantity exchange matrix from the region C to the region A, P_{ab} represents an electricity quantity exchange matrix from the region A to the region B, P_{cb} represents an electricity quantity exchange matrix from the region C to the region B, P_{ac} represents an electricity quantity exchange matrix from the region A to the region C, λₐ represents an electricity quantity carbon emission factor matrix of the region A, λ_{b} represents an electricity carbon emission factor matrix of the region B, λ_{c} represents an electricity carbon emission factor matrix of the region C, Cₐ represents a power-generation carbon emission information matrix of the region A, C_{b} represents a power-generation carbon emission information matrix of region B, and C_{c} represents a power-generation carbon emission information matrix of the region C.

According to the above formula, the following are obtained:

$${M}_{a} {λ}_{a} + {P}_{b a} {λ}_{b} + {P}_{c a} {λ}_{c} = {C}_{a}$$

$${M}_{b} {λ}_{b} + {P}_{a b} {λ}_{a} + {P}_{c b} {λ}_{c} = {C}_{b}$$

$${M}_{c} {λ}_{c} + {P}_{a c} {λ}_{a} + {P}_{b c} {λ}_{b} = {C}_{c}$$

Therefore,

$${λ}_{a} = {M}_{a}^{- 1} {C}_{a} - {M}_{a}^{- 1} {P}_{b a} {λ}_{b} - {M}_{a}^{- 1} {P}_{c a} {λ}_{c}$$

In other words,

$${λ}_{a} = {λ}_{a}^{( 0 )} - {D}_{b a} {λ}_{b} - {D}_{c a} {λ}_{c}$$

Similarly, the following are obtained:

$$\begin{matrix}{λ}_{b} = {λ}_{b}^{( 0 )} - {D}_{ab} {λ}_{a} - {D}_{cb} {λ}_{c} \\ {λ}_{c} = {λ}_{a}^{( 0 )} - {D}_{ab} {λ}_{b} - {D}_{bc} {λ}_{b}\end{matrix}$$

Afterwards, the block-Jacobi iteration method is used for iterative correction.

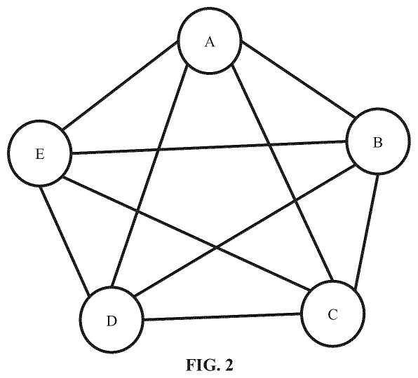

During iteration or data correction, terminals in the regions are fully connected, as shown in FIG. 2.

This method adopts a distributed layout. A power grid company responsible for each region establishes a terminal, and a Transmission Control Protocol (TCP)/an Internet Protocol (IP) is used for communication. The communication adopts a triple retransmission mechanism. Specifically, an instruction is resent if no feedback is received from the other party within 20 seconds after issuing the instruction, and it is considered that a link is interrupted or the other party goes offline if the instruction is sent more than three times. In a process from initiation of calculation to termination of the calculation in collaborative communication, communication steps are as follows:
1) A server of each terminal broadcasts “ready”. If no feedback is received from one terminal, it is considered as unable to be ready.
2) The server of each terminal confirms that a ready state is available in 20 s, and the terminal enters a “collaborative calculation” state, and sets its own iteration quantity k=0.
3) After calculation, the server of each terminal sends λ_{τ}^{(k)} and k_{τ} to a server of another terminal, and the another terminal returns a response. If no feedback is received after the communication is performed three times, the server of the terminal stops iteration, and the terminal transitions to an “interrupted state”.
4) The server of each terminal receives λ_{μ}^{(k)} and k_{μ} of the another terminal, and performs calculation. Assuming a local iteration quantity is k_{τ}, if kμ≠k_{τ}, the server of the terminal changes the state to the “interrupted state”. If k_{μ}=k_{τ}, k_{τ} of the server of the terminal increases by 1, namely, k_{τ}=k_{τ}+1, and one iterative calculation is performed.
5) The server of each terminal sends information to confirm that the terminal is in the “collaborative calculation” state. If any terminal is in the “interrupted state”, the server of each terminal changes its state to “ready” and restarts the step 1). If all terminals are in the “collaborative calculation” state, the step 3) is performed.

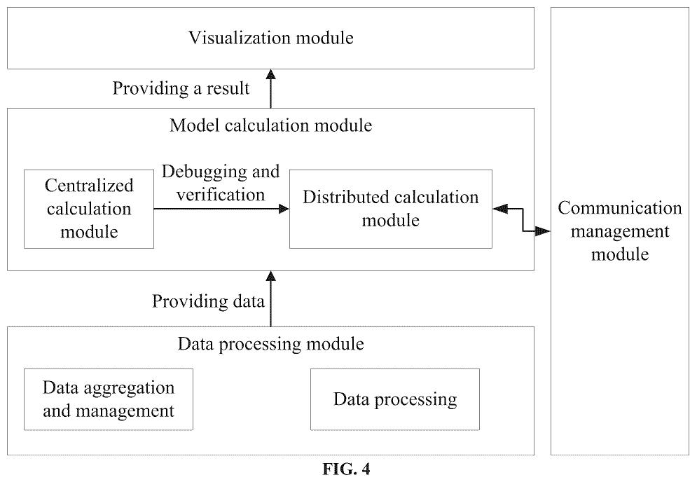

FIG. 3 is a schematic diagram of a calculation procedure by taking regions A and B as an example. The region A corresponds to a “terminal of a company in a region 1”, and the region B corresponds to a “terminal of a company in a region 2”. A schematic diagram of a corresponding software module is shown in FIG. 4. In FIG. 4, multi-terminal deployment is used, and data transmission is performed through the Internet. This method adopts distributed deployment.

A software instance includes following modules:
a data processing module: responsible for collecting, storing, and managing inter-provincial electricity exchange data, power generation data, and carbon emission data from a company's terminal managed by a power grid in the region A or B;
a model calculation module: responsible for running a model according to the above steps to perform calculation;
a communication management module: responsible for ensuring synchronous communication between both parties and smoothness of the link, and providing reliability assurance in case of a link failure; and
a visualization module: provides map display, large screen display, and other functions to display a settlement result.

In the embodiments of the present disclosure, the data processing module, the model calculation module, and the communication management module each may be one or more processors, controllers, or chips that each have a communication interface, can realize a communication protocol, and may further include a memory, a related interface and system transmission bus, and the like if necessary. The processor, controller, or chip executes program-related code to realize a corresponding function. In an alternative solution, the data processing module, the model calculation module, and the communication management module share an integrated chip or share devices such as a processor, a controller, and a memory. The shared processor, controller, or chip executes program-related code to implement a corresponding function.

In the present disclosure, taking China as an example, different power grid companies are responsible for power operation in different regions, namely State Grid Corporation of China, China Southern Power Grid Company, and Inner Mongolia Power (Group) Co., Ltd. (Mengxi Power Grid). They are responsible for power operation of various provinces in China. The sub-region in the present disclosure can calculate an electricity carbon emission factor of each province by taking the province as a standard.

The method provided in the present disclosure can hide scheduling information of a plurality of regions, and achieve multi-party collaborative calculation while ensuring accuracy of a calculation result, thereby solving a difficulty in managing data from both parties.

### Embodiment 2

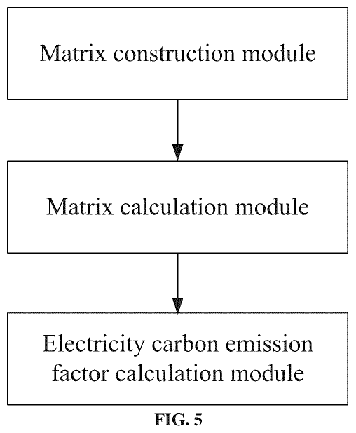

Based on a same inventive concept, the present disclosure provides a distributed collaborative privacy calculation system for carbon emission in a plurality of power grids. As shown in FIG. 5, the system includes a matrix construction module, a matrix calculation module, and an electricity carbon emission factor calculation module.

The matrix construction module is configured to obtain a transferred electricity quantity between regions, obtain a generating capacity of a sub-region under jurisdiction of each region, a transferred electricity quantity between sub-regions, and a generating capacity of energy of the sub-region, and construct an electricity quantity exchange matrix between the regions, and a power generation information matrix, an electricity quantity exchange matrix, and a power-generation carbon emission information matrix of each region based on the obtained information.

The matrix calculation module is configured to calculate a corresponding electricity carbon flow information matrix based on the power generation information matrix and the electricity quantity exchange matrix of each region.

The electricity carbon emission factor calculation module is configured to construct an electricity carbon emission balance equation based on the electricity carbon flow information matrix and the power-generation carbon emission information matrix of each region, and the electricity quantity exchange matrix between the regions, and calculate an electricity carbon emission factor matrix of each region, where the electricity carbon emission factor matrix of the region includes an electricity carbon emission factor of the sub-region under the jurisdiction of the region.

The electricity carbon emission balance equation in the electricity carbon emission factor calculation module is expressed by a following calculation formula:

$$[ \begin{matrix}{M}_{1} & … & {P}_{τ 1} & … & {P}_{L 1} \\ ⋮ & ⋱ & ⋮ & … & ⋮ \\ {P}_{1 τ} & … & {M}_{τ} & … & {P}_{L τ} \\ ⋮ & … & ⋮ & ⋱ & ⋮ \\ {P}_{1 L} & … & {P}_{τ L} & … & {M}_{L}\end{matrix} ] [ \begin{matrix}{λ}_{1} \\ ⋮ \\ {λ}_{τ} \\ ⋮ \\ {λ}_{L}\end{matrix} ] = [ \begin{matrix}{C}_{1} \\ ⋮ \\ {C}_{τ} \\ ⋮ \\ {C}_{L}\end{matrix} ]$$

In the above formula, M_{τ} represents an electricity carbon flow information matrix of a τ^{th} region; P_{τL} represents an electricity quantity exchange matrix from the τ^{th} region to an L^{th} region; λ_{τ} represents an electricity carbon emission factor matrix of the τ^{th} region; and C_{τ} represents a power-generation carbon emission information matrix of the τ^{th} region.

The electricity carbon emission factor matrix in the electricity carbon emission factor calculation module is calculated according to a following calculation formula:

$${λ}_{τ} = {λ}_{τ}^{( 0 )} - {\sum }_{μ} {D}_{μ τ} {λ}_{μ}$$

In the above formula,

$${λ}_{τ}^{( 0 )} = {M}_{τ}^{- 1} {C}_{τ}$$

$${D}_{μ τ} = {M}_{τ}^{- 1} {P}_{μ τ}$$

In the above formulas, λ_{τ} represents the electricity carbon emission factor matrix of the τ^{th} region; C_{τ} represents the power-generation carbon emission information matrix of the τ^{th} region; λ_{τ} represents an electricity carbon emission factor matrix of a μ^{th} region; P_{μτ} represents an electricity quantity exchange matrix from the μ^{th} region to the τ^{th} region; M_{τ} represents the electricity carbon flow information matrix of the τ^{th} region; D_{μτ} represents an interactive power flow matrix between sub-regions from the μ^{th} region to the τ^{th} region; and λ_{τ}⁽⁰⁾ represents an initial iteration value of the electricity carbon emission factor matrix of the τ^{th} region.

The power generation information matrix of the region in the matrix construction module is expressed by a following calculation formula:

$$E = [ \begin{matrix}{E}_{1} & 0 & … & 0 & … & 0 \\ 0 & {E}_{2} & … & 0 & … & 0 \\ ⋮ & ⋮ & ⋱ & ⋮ & … & ⋮ \\ 0 & 0 & … & {E}_{i} & … & 0 \\ ⋮ & ⋮ & ⋮ & ⋮ & ⋱ & ⋮ \\ 0 & 0 & … & 0 & … & {E}_{N}\end{matrix} ]$$

In the above formula, E represents the power generation information matrix of the region, Eᵢ represents a generating capacity of an i^{th} sub-region under the jurisdiction of the region, and N represents a quantity of sub-regions under the jurisdiction of the region.

The electricity quantity exchange matrix of the region in the matrix construction module is expressed by a following calculation formula:

$$P = [ \begin{matrix}0 & {P}_{2 , 1} & … & {P}_{i , 1} & … & {P}_{N , 1} \\ {P}_{1 , 2} & 0 & … & {P}_{i , 2} & … & {P}_{N , 2} \\ ⋮ & ⋮ & ⋱ & ⋮ & … & ⋮ \\ {P}_{1 , j} & {P}_{2 , j} & … & 0 & … & {P}_{N , j} \\ ⋮ & ⋮ & ⋮ & ⋮ & ⋱ & ⋮ \\ {P}_{1 , N} & {P}_{2 , N} & … & {P}_{i , N} & … & 0\end{matrix} ]$$

In the above formula, P represents the electricity quantity exchange matrix of the region, P_{i,j} represents a transferred electricity quantity from the i^{th} sub-region to a j^{th} sub-region, and N represents the quantity of sub-regions under the jurisdiction of the region.

The power-generation carbon emission information matrix of the region in the matrix construction module is expressed by a following calculation formula:

$$C = [ \begin{matrix}{\sum }_{m} {E}_{1 ,} {ε}_{m} \\ {\sum }_{m} {E}_{2 , m} {ε}_{m} \\ ⋮ \\ {\sum }_{m} {E}_{i , m} {ε}_{m} \\ ⋮ \\ {\sum }_{m} {E}_{N , m} {ε}_{m}\end{matrix} ]$$

In the above formula, C represents the power-generation carbon emission information matrix of the region, E_{i,m} represents a generating capacity of an m^{th} type of energy in the i^{th} sub-region, and εₘ represents a power-generation carbon emission factor corresponding to the generating capacity of the m^{th} type of energy.

The electricity carbon flow information matrix of the region in the matrix calculation module is calculated according to a following calculation formula:

$$M = E - P + diag ( P [ 1 ] )$$

In the above formula, M represents the electricity carbon flow information matrix of the region, E represents the power generation information matrix of the region, P represents the electricity quantity exchange matrix of the region, [1] represents a vector that contains only 1, P[1] represents a vector obtained by multiplying the P and the [1], and diag(P[1]) represents an operation of placing the vector on a diagonal of a matrix, with a non-diagonal element being 0.

In the present disclosure, after the electricity carbon emission factor calculation module calculates the electricity carbon emission factor matrix of each region, the system further includes:
an iterative correction module configured to iteratively correct the electricity carbon emission factor matrix between the regions pairwise by using a block-Jacobi iteration method based on a preset iteration termination threshold, until the iteration satisfies the iteration termination threshold, and obtain an electricity carbon emission factor matrix of each region after the iterative correction.

In the embodiments of the present disclosure, the matrix construction module, the matrix calculation module, the electricity carbon emission factor calculation module, and the iterative correction module each may be one or more processors, controllers, or chips that each have a communication interface, can realize a communication protocol, and may further include a memory, a related interface and system transmission bus, and the like if necessary. The processor, controller, or chip executes program-related code to realize a corresponding function. In an alternative solution, the matrix construction module, the matrix calculation module, the electricity carbon emission factor calculation module, and the iterative correction module share an integrated chip or share devices such as a processor, a controller, and a memory. The shared processor, controller, or chip executes program-related code to implement a corresponding function.

### Embodiment 3

Based on a same inventive concept, the present disclosure further provides a computer device. The computer device includes a processor and a memory. The memory is configured to store a computer program that includes a program instruction, and the processor is configured to execute the program instruction stored in the memory. The processor may be a central processing unit (CPU), and may also be another general-purpose processor, a digital signal processor (DSP), an application specific integrated circuit (ASIC), a field-programmable gate array (FPGA) or another programmable logic device, a discrete gate, a transistor logic device, a discrete hardware component, or the like. As a calculation core and a control core of the computer device, the processor is suitable for implementing at least one instruction, specifically suitable for loading and executing at least one instruction in the computer storage medium to achieve corresponding methods, procedures, or functions, in order to achieve the steps of the distributed collaborative privacy calculation method for carbon emission in a plurality of power grids in the above embodiments.

### Embodiment 4

Based on a same inventive concept, the present disclosure further provides a storage medium, specifically a computer-readable storage medium (memory). The computer-readable storage medium is a memory device in a computer device for storing programs and data. It can be understood that the computer-readable storage medium herein may include a built-in storage medium in the computer device, and certainly may also include an extended storage medium supported by the computer device. The computer-readable storage medium provides storage space that stores an operating system of the computer device. Moreover, the storage space also stores at least one instruction suitable for being loaded and executed by a processor. The at least one instruction may be at least one computer program (including program code). It should be noted that the computer-readable storage medium herein may be a high-speed random access memory (RAM) or a non-volatile memory, such as at least one disk memory. The at least one instruction stored in the computer-readable storage medium can be loaded and executed by the processor to implement the steps of the distributed collaborative privacy calculation method for carbon emission in a plurality of power grids in the above embodiments.

A person skilled in the art should understand that the embodiments in the present disclosure may be provided as a method, a system, or a computer program product. Therefore, the present disclosure may use a form of hardware only embodiments, software only embodiments, or embodiments with a combination of software and hardware. Moreover, the present disclosure may use a form of a computer program product that is implemented on at least one computer-usable storage medium (including but not limited to a magnetic disk memory, a CD-ROM, an optical memory, and the like) that include computer-usable program code.

The present disclosure is described with reference to the flowcharts and/or block diagrams of the method, the device (system), and the computer program product according to the embodiments of the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing device to generate a machine, such that the instructions executed by a computer or a processor of another programmable data processing device generate an apparatus for implementing a specific function in one or more processes in the flowcharts and/or in one or more blocks in the block diagrams.

These computer program instructions may be stored in a computer-readable memory that can instruct a computer or another programmable data processing device to work in a specific manner, such that the instructions stored in the computer-readable memory generate an artifact that includes an instruction apparatus. The instruction apparatus implements a specific function in one or more processes in the flowcharts and/or in one or more blocks in the block diagrams.

These computer program instructions may alternatively be loaded onto a computer or another programmable data processing device, such that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Finally, it should be noted that the above embodiments are merely intended to describe the technical solutions of the present disclosure, rather than to limit the protection scope of the present disclosure. Although the present disclosure is described in detail with reference to the above embodiments, it is to be appreciated by a person of ordinary skill in the art that changes, modifications, or equivalent substitutions may still be made to the specific implementations of the present disclosure, and these changes, modifications, or equivalent substitutions shall fall within the protection scope of the claims of the present disclosure.

1. A distributed collaborative privacy calculation method for carbon emission in a plurality of power grids, comprising:
obtaining a transferred electricity quantity between regions, obtaining a generating capacity of a sub-region under jurisdiction of each of the regions, a transferred electricity quantity between sub-regions, and a generating capacity of energy of the sub-region, and constructing an electricity quantity exchange matrix between the regions, and a power generation information matrix, an electricity quantity exchange matrix, and a power-generation carbon emission information matrix of each of the regions based on the obtained information;
calculating a corresponding electricity carbon flow information matrix based on the power generation information matrix and the electricity quantity exchange matrix of each of the regions; and
constructing an electricity carbon emission balance equation based on the electricity carbon flow information matrix and the power-generation carbon emission information matrix of each of the regions, and the electricity quantity exchange matrix between the regions, and calculating an electricity carbon emission factor matrix of each of the regions, wherein the electricity carbon emission factor matrix of the region comprises an electricity carbon emission factor of the sub-region under the jurisdiction of the region.

2. The method according to claim 1, wherein the electricity carbon emission balance equation is expressed by a following calculation formula:
$$[ \begin{matrix}{M}_{1} & … & {P}_{τ 1} & … & {P}_{L 1} \\ ⋮ & ⋱ & ⋮ & … & ⋮ \\ {P}_{1 τ} & … & {M}_{τ} & … & {P}_{L τ} \\ ⋮ & … & ⋮ & ⋱ & ⋮ \\ {P}_{1 L} & … & {P}_{τ L} & … & {M}_{L}\end{matrix} ] [ \begin{matrix}{λ}_{1} \\ ⋮ \\ {λ}_{τ} \\ ⋮ \\ {λ}_{L}\end{matrix} ] = [ \begin{matrix}{C}_{1} \\ ⋮ \\ {C}_{τ} \\ ⋮ \\ {C}_{L}\end{matrix} ]$$
wherein M_{τ} represents an electricity carbon flow information matrix of a τ^{th} region; P_{τL} represents an electricity quantity exchange matrix from the τ^{th} region to an L^{th} region; P_{Lτ} represents an electricity quantity exchange matrix from the L^{th} region to the τ^{th} region; λ_{τ} represents an electricity carbon emission factor matrix of the τ^{th} region; and C_{τ} represents a power-generation carbon emission information matrix of the τ^{th} region.

3. The method according to claim 2, wherein the electricity carbon emission factor matrix is calculated according to a following calculation formula:
$${λ}_{τ} = {λ}_{τ}^{( 0 )} - {\sum }_{μ} {D}_{μ τ} {λ}_{μ}$$
wherein
$${λ}_{τ}^{( 0 )} = {M}_{τ}^{- 1} {C}_{τ}$$
$${D}_{μ τ} = {M}_{τ}^{- 1} {P}_{μ τ}$$
wherein λ_{τ} represents the electricity carbon emission factor matrix of the τ^{th} region; C_{τ} represents the power-generation carbon emission information matrix of the τ^{th} region; λ_{μ} represents an electricity carbon emission factor matrix of a μ^{th} region; P_{μτ} represents an electricity quantity exchange matrix from the μ^{th} region to the τ^{th} region; M_{τ} represents the electricity carbon flow information matrix of the τ^{th} region; D_{μτ} represents an interactive power flow matrix between sub-regions from the μ^{th} region to the τ^{th} region; and λ_{τ}⁽⁰⁾ represents an initial iteration value of the electricity carbon emission factor matrix of the τ^{th} region.

4. The method according to claim 1, wherein the power generation information matrix of the region is expressed by a following calculation formula:
$$E = [ \begin{matrix}{E}_{1} & 0 & … & 0 & … & 0 \\ 0 & {E}_{2} & … & 0 & … & 0 \\ ⋮ & ⋮ & ⋱ & ⋮ & … & ⋮ \\ 0 & 0 & … & {E}_{i} & … & 0 \\ ⋮ & ⋮ & ⋮ & ⋮ & ⋱ & ⋮ \\ 0 & 0 & … & 0 & … & {E}_{N}\end{matrix} ]$$
wherein E represents the power generation information matrix of the region, Eᵢ represents a generating capacity of an i^{th} sub-region under the jurisdiction of the region, and N represents a quantity of sub-regions under the jurisdiction of the region;
the electricity quantity exchange matrix of the region is expressed by a following calculation formula:
$$P = [ \begin{matrix}0 & {P}_{2 , 1} & … & {P}_{i , 1} & … & {P}_{N , 1} \\ {P}_{1 , 2} & 0 & … & {P}_{i , 2} & … & {P}_{N , 2} \\ ⋮ & ⋮ & ⋱ & ⋮ & … & ⋮ \\ {P}_{1 , j} & {P}_{2 , j} & … & 0 & … & {P}_{N , j} \\ ⋮ & ⋮ & ⋮ & ⋮ & ⋱ & ⋮ \\ {P}_{1 , N} & {P}_{2 , N} & … & {P}_{i , N} & … & 0\end{matrix} ]$$
wherein P represents the electricity quantity exchange matrix of the region, P_{i,j} represents a transferred electricity quantity from the i^{th} sub-region to a j^{th} sub-region, and N represents the quantity of sub-regions under the jurisdiction of the region; and
the power-generation carbon emission information matrix of the region is expressed by a following calculation formula:
$$C = [ \begin{matrix}{\sum }_{m} {E}_{1 ,} {ε}_{m} \\ {\sum }_{m} {E}_{2 , m} {ε}_{m} \\ ⋮ \\ {\sum }_{m} {E}_{i , m} {ε}_{m} \\ ⋮ \\ {\sum }_{m} {E}_{N , m} {ε}_{m}\end{matrix} ]$$
wherein C represents the power-generation carbon emission information matrix of the region, E_{i,m} represents a generating capacity of an mₜₕ type of energy in the i^{th} sub-region, and εₘ represents a power-generation carbon emission factor corresponding to the generating capacity of the m^{th} type of energy.

5. The method according to claim 4, wherein the electricity carbon flow information matrix of the region is calculated according to a following calculation formula:
$$M = E - P + diag ( P [ 1 ] )$$
wherein M represents the electricity carbon flow information matrix of the region, E represents the power generation information matrix of the region, P represents the electricity quantity exchange matrix of the region, [1] represents a vector that contains only 1, P[1] represents a vector obtained by multiplying the P and the [1], and diag(P[1]) represents an operation of placing the vector on a diagonal of a matrix, with a non-diagonal element being 0.

6. The method according to claim 1, after the calculating an electricity carbon emission factor matrix of each of the regions, further comprising:
iteratively correcting the electricity carbon emission factor matrix between the regions pairwise by using a block-Jacobi iteration method based on a preset iteration termination threshold, until the iteration satisfies the iteration termination threshold, and obtaining an electricity carbon emission factor matrix of each of the regions after the iterative correction.

7. A distributed collaborative privacy calculation system for carbon emission in a plurality of power grids, comprising:
a matrix construction module configured to obtain a transferred electricity quantity between regions, obtain a generating capacity of a sub-region under jurisdiction of each of the regions, a transferred electricity quantity between sub-regions, and a generating capacity of energy of the sub-region, and construct an electricity quantity exchange matrix between the regions, and a power generation information matrix, an electricity quantity exchange matrix, and a power-generation carbon emission information matrix of each of the regions based on the obtained information;
a matrix calculation module configured to calculate a corresponding electricity carbon flow information matrix based on the power generation information matrix and the electricity quantity exchange matrix of each of the regions; and
an electricity carbon emission factor calculation module configured to construct an electricity carbon emission balance equation based on the electricity carbon flow information matrix and the power-generation carbon emission information matrix of each of the regions, and the electricity quantity exchange matrix between the regions, and calculate an electricity carbon emission factor matrix of each of the regions, wherein the electricity carbon emission factor matrix of the region comprises an electricity carbon emission factor of the sub-region under the jurisdiction of the region.

8. The system according to claim 7, wherein after the electricity carbon emission factor calculation module calculates the electricity carbon emission factor matrix of each of the regions, the system further comprises:
an iterative correction module configured to iteratively correct the electricity carbon emission factor matrix between the regions pairwise by using a block-Jacobi iteration method based on a preset iteration termination threshold, until the iteration satisfies the iteration termination threshold, and obtain an electricity carbon emission factor matrix of each of the regions after the iterative correction.

9. A computer device, comprising at least one processor, and a memory configured to store at least one program, wherein
the at least one program is executed by the at least one processor to implement the distributed collaborative privacy calculation method for carbon emission in a plurality of power grids according to claim 1.

10. A computer device, comprising at least one processor, and a memory configured to store at least one program, wherein
the at least one program is executed by the at least one processor to implement the distributed collaborative privacy calculation method for carbon emission in a plurality of power grids according to claim 2.

11. A computer device, comprising at least one processor, and a memory configured to store at least one program, wherein
the at least one program is executed by the at least one processor to implement the distributed collaborative privacy calculation method for carbon emission in a plurality of power grids according to claim 3.

12. A computer device, comprising at least one processor, and a memory configured to store at least one program, wherein
the at least one program is executed by the at least one processor to implement the distributed collaborative privacy calculation method for carbon emission in a plurality of power grids according to claim 4.

13. A computer device, comprising at least one processor, and a memory configured to store at least one program, wherein
the at least one program is executed by the at least one processor to implement the distributed collaborative privacy calculation method for carbon emission in a plurality of power grids according to claim 5.

14. A computer device, comprising at least one processor, and a memory configured to store at least one program, wherein
the at least one program is executed by the at least one processor to implement the distributed collaborative privacy calculation method for carbon emission in a plurality of power grids according to claim 6.

15. A computer-readable storage medium, wherein a computer program is stored on the computer-readable storage medium, and the computer program is executed to implement the distributed collaborative privacy calculation method for carbon emission in a plurality of power grids according to claim 1.

16. A computer-readable storage medium, wherein a computer program is stored on the computer-readable storage medium, and the computer program is executed to implement the distributed collaborative privacy calculation method for carbon emission in a plurality of power grids according to claim 2.

17. A computer-readable storage medium, wherein a computer program is stored on the computer-readable storage medium, and the computer program is executed to implement the distributed collaborative privacy calculation method for carbon emission in a plurality of power grids according to claim 3.

18. A computer-readable storage medium, wherein a computer program is stored on the computer-readable storage medium, and the computer program is executed to implement the distributed collaborative privacy calculation method for carbon emission in a plurality of power grids according to claim 4.

19. A computer-readable storage medium, wherein a computer program is stored on the computer-readable storage medium, and the computer program is executed to implement the distributed collaborative privacy calculation method for carbon emission in a plurality of power grids according to claim 5.

20. A computer-readable storage medium, wherein a computer program is stored on the computer-readable storage medium, and the computer program is executed to implement the distributed collaborative privacy calculation method for carbon emission in a plurality of power grids according to claim 6.
